(19) United States
(12) Patent Application Publication
(10) Pub. No.: US 2026/0261170 A1
(43) Pub. Date: Sep. 3, 2026

(54) STATOR WITH IN-SLOT CENTER TO END COOLANT FLOW

(71) Applicant: FORD GLOBAL TECHNOLOGIES, LLC, Dearborn, MI (US)

(72) Inventors: Kodie Olshefsky, Detroit, MI (US); Akash Changarankumarath Pradeepkumar, Westland, MI (US); Singar Rathnam, Farmington Hills, MI (US)

(21) Appl. No.: 19/066,232

(22) Filed: Feb. 28, 2025

(51) Int. Cl. H02K 1/20

(52) U.S. Cl. CPC H02K 1/20

(57) ABSTRACT

A stator for an electric machine includes a core composed of stacked laminations with axially extending slots for windings and an integrated cooling system. A circumferential ring encircles the slots, with ports providing fluid pathways to facilitate cooling. An axial channel, positioned radially outside the circumferential ring, extends from an inlet to the stator’s center, directing fluid flow through the core. The laminations define both the circumferential and axial channels. In a vehicle propulsion system, this stator design facilitates cooling by guiding fluid through the slots via a pump-driven pathway.

### TECHNICAL FIELD

The present disclosure relates to a stator of an electric machine, and the cooling thereof.

### BACKGROUND

An electric machine may include a stator and a rotor that cooperate to convert electrical energy into mechanical energy, or vice versa. This conversion may generate heat.

A stator may include a plurality of laminations and windings.

### SUMMARY

A stator for an electric machine comprises a plurality of stacked laminations forming a stator core with axially extending slots. One lamination partially defines an annular ring encircling the slots, while another, in direct contact with the first, defines multiple ports extending from the slots and overlapping with portions of the annular ring. This configuration creates fluid pathways from the annular ring, through the ports and slots, and to both axial ends of the stator core. Additionally, the stator core includes a cylindrical void extending between its axial ends, with a sealing layer positioned within the void to seal the slots. A first lamination defines an inlet, and some laminations form an axial passage connecting the inlet to the centrally positioned lamination. Windings are disposed within the slots to further complete the stator assembly.

A vehicle propulsion system includes an electric machine with a stator core that houses slots for windings and an integrated cooling path designed to direct fluid from an inlet at one end of the core to the slots. The cooling path includes an axial channel and a circumferential ring surrounding the slots, with a pump facilitating fluid movement through the system. The axial channel is positioned radially outside the circumferential ring and is formed by specific laminations within the stator core, while other laminations define the circumferential ring.

An electric machine includes a stator core with multiple slots designed to accommodate windings, a circumferential channel positioned radially outside the slots and in fluid communication with them, and an axial channel that extends between the circumferential channel and an end of the stator core. The stator core is formed by stacked laminations, with an adjacent pair of laminations defining the circumferential channel. One of these laminations also defines ports that provide fluid communication between the circumferential channel and the slots, with each port aligned with a corresponding slot. The axial channel, which is shorter than the stator core, is positioned radially outside the circumferential channel, which fully encircles the slots to facilitate fluid distribution and cooling.

### BRIEF DESCRIPTION OF THE DRAWINGS

FIG. 1 is a perspective view of a stator.

FIG. 2. is a side view, in cross-section, of the stator of FIG. 1 taken along line A-A.

FIG. 3 is a top perspective view, in cross-section, of the stator of FIG. 1 taken along line B-B.

FIG. 4 is bottom perspective view, in cross-section, of the stator of FIG. 1 taken along line C-C.

FIG. 5 is a side perspective view, in cross-section, of a stator and an associated cooling system.

### DETAILED DESCRIPTION

Detailed embodiments are disclosed herein. These embodiments are merely exemplary and may be embodied in various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

Directional terms used herein are made with reference to the views and orientations shown in the figures. A central axis is shown in the figures and described below. Terms such as “outer” and “inner” are relative to the central axis. For example, an “outer” surface means that the surfaces face away from the central axis or is outboard of another “inner” surface. Terms such as “radial,” “diameter,” “circumference,” etc. also are relative to the central axis. The terms “front,” “rear,” “upper,” and “lower” designate directions in the drawings to which reference is made. The terms, connected, attached, etc., refer to directly or indirectly connected, attached, etc., unless otherwise indicated explicitly or by context.

The cooling mechanisms described herein affect stator performance by enabling coolant flow within the stator slots. This allows the coolant to make direct contact with the magnet wires. In-slot cooling facilitates direct axial cooling of the motor windings, increasing cooling efficiency and supporting continuous motor operation. Additionally, axial cooling enables bi-directional coolant flow within the stator. These cooling mechanisms may include three components: unit 1, which transfers coolant axially from the stator face toward its center; unit 2, which distributes coolant radially around the stator circumference; and/or unit 3, which delivers coolant to each slot of the stator through dedicated ports. The coolant flow transitions from axial to circumferential distribution in unit 2 and from circumferential to radial and axial distribution in unit 3. There is an overlap between the second and third cooling units at specific stator laminations, which may occur across adjacent groups of laminations.

Cooling efficiency is affected by directly targeting the motor’s primary heat source and increasing contact between the coolant, magnet wires, and stator. Reducing thermal resistance in the magnet wires further affects stator efficiency, allowing the motor to maintain peak performance continuously and operate at higher levels for longer periods. This is achieved without the need for additional heaters, maximizing overall efficiency. A higher power density enables a shorter stator stack length. The system is also scalable, requiring only minor adjustments for implementation across different stators.

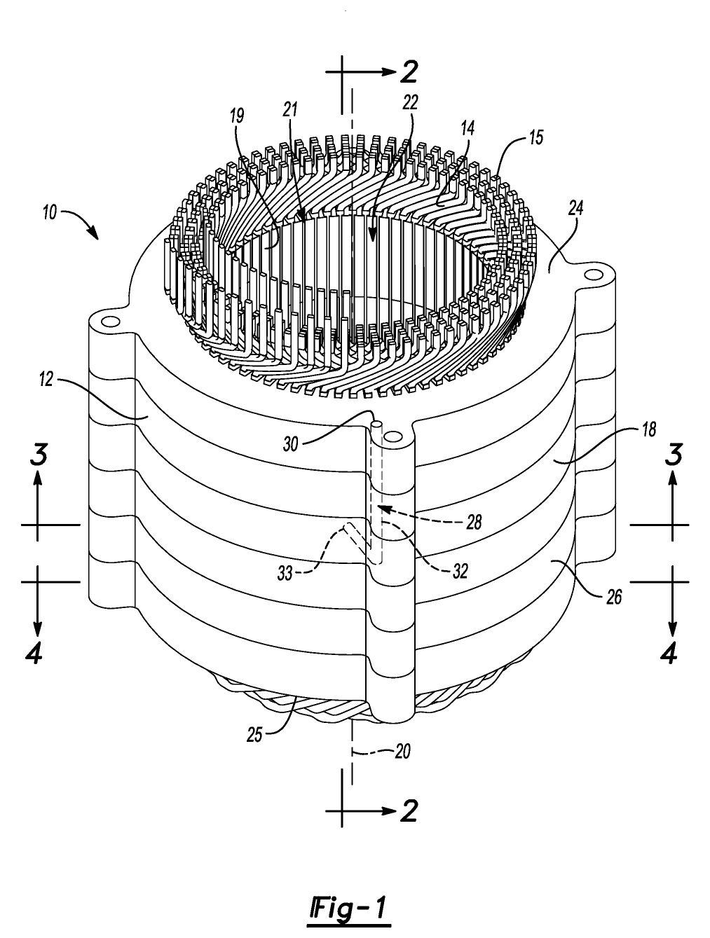

An example stator, identified as stator 10, is shown in FIG. 1. Stator 10 includes a core 12, windings 14, and a high-voltage terminal 16. Core 12 is made up of multiple stacked laminations, with the total number depending on the size requirements of stator 10. For example, core 12 may contain as few as 10 laminations or as many as 5,000. However, other quantities—including fewer than 10, more than 5,000, or any number in between—are also possible and contemplated in this disclosure.

Each lamination 18 in the stack has a top and bottom side. A stack of laminations 18 may be arranged such that the top or bottom side of one lamination 18 is in contact with a corresponding top or bottom side of an adjacent lamination 18 to form the stack. Each lamination 18 has an inner diameter and an outer diameter. When the laminations 18 are stacked, the inner diameter of each collectively forms the inner diameter of stator 10. The inner diameter of stator 10 defines cylindrical void 22 extending through the length of stator 10 between the first and last lamination 18 in the stack. The outer diameter of each lamination 18 in the stack collectively forms the outer diameter of stator 10. The outer diameter of stator 10 defines cylindrical face 26 between the first and last lamination 18 in the stack. Stator 10 has a central axis 20, with the plurality of laminations 18 arranged to be aligned and coaxial with central axis 20, making cylindrical void 22 and cylindrical face 26 concentric with central axis 20. Stator 10 further includes axial faces 24, 25. The top surface of first lamination 18 in the stack defines axial face 24, and the bottom surface of last lamination 18 in the stack defines axial face 25. A normal vector to both axial faces 24, 25 may be parallel with central axis 20.

Each lamination 18 in the stack includes a plurality of teeth 19 extending radially inward toward the inner diameter of lamination 18. Adjacent teeth 19 of each lamination 18 cooperate to define radially extending slots between teeth 19. When laminations 18 are stacked and oriented so that teeth 19 of adjacent laminations 18 align, the individual slots combine to form a plurality of slots 21 that extend axially through the stator 10 between axial faces 24, 25.

Windings 14, also referred to as coils, wires, or conductors, are wrapped around core 12 and disposed within axial slots 21. Windings 14 may be insulated with a sleeve disposed around portions thereof and/or embedded in varnish. The insulating sleeve and/or varnish may help to stabilize the windings within the slots. Additionally, the insulating sleeve and/or varnish may electrically isolate windings 14 from other portions of stator 10. A portion of windings 14 generally extends in the axial direction along and through slots 21, while at axial faces 24, 25, portions of the windings 14 curve to form end windings 15. End windings 15 extend beyond axial faces 24, 25. Windings 14 may be supported by the axial slots 21. Although windings 14 are depicted as hairpin-style windings, other configurations, such as distributed windings, among others, are also possible.

Stator 10 includes a cooling fluid delivery sub-stack 28. Cooling fluid delivery sub-stack 28 may include cooling fluid inlet port 30, axial passage 32, and cooling fluid outlet port 33. Cooling fluid delivery sub-stack 28 is configured to transfer a cooling fluid axially from axial face 24 toward the center of stator 10 through axial passage 32 that extends through some laminations 18 in the stack. The cooling fluid inlet port 30 is an aperture on axial face 24. Axial passage 32 extends axially from cooling fluid inlet port 30 toward the center of stator 10 in a direction substantially parallel to central axis 20. Axial passage 32 terminates at cooling fluid outlet port 33. Cooling fluid outlet port 33 may be in the center of the stack. The center of the stack may be defined as the middle lamination in the stack. Cooling fluid outlet port 33, however, may be disposed at locations other than the middle of the stack.

Axial passage 32 is formed by adjacent laminations 18 that cooperate to form axial passage 32. For example, a portion of axial passage 32 may be a circular shaped cutout in an individual lamination 18 in the stack. When adjacent laminations 18 having this circular shaped cutout are stacked and aligned, they cooperate to form axial passage 32. For example, if stator 10 has 500 sequentially numbered laminations 18, with top lamination 18 numbered 1 defining axial face 24, circular cutouts in laminations 18 numbered 1–250 may cooperate to define axial passage 32. Other amounts and ranges of adjacent laminations 18 may cooperate to form axial passage 32. Further, as previously discussed, a stator may have more than 500 laminations 18 or fewer than 500 laminations 18. A cutout may refer to a hole, aperture, opening, bore, or any other suitable shape that extends through and between the top and bottom surfaces of a lamination 18.

Cooling fluid outlet port 33 is a passage that extends radially inwards through stator 10. Cooling fluid outlet port 33 may be defined by one lamination 18 or multiple laminations 18. Because cooling fluid outlet port 33 traverses radially, rather than axially, adjacent laminations to the ones defines cooling fluid outlet port 33 are required to seal the outlet port 33. In some embodiments, cooling fluid outlet port 33 may be defined by a radially extending cutout that extends radially through a portion of adjacent laminations 18 in the stack. For example, if stator 10 has 500 sequentially numbered laminations 18, cutouts in laminations 18 numbered 225–250 may cooperate to define cooling fluid outlet port 33. In this embodiment, laminations 18 numbered 224 and 251, without the cutout, would seal cooling fluid outlet port 33. In other embodiments, for example, cooling fluid outlet port 33 is defined by a single lamination 18 in the stack, with adjacent laminations 18 to the one sealing the port 33. For example, if stator 10 has 500 sequentially numbered laminations 18, a cutout in lamination 18 numbered 250 may define cooling fluid outlet port 33, and laminations 18 numbered 249 and 251 seal the outlet port 33. Cooling fluid outlet port 33 in this embodiment may be formed at different positions within the stack. The cutouts that define cooling fluid outlet port 33 and a portion of axial passage 32 may be integral to each other and cooperate to form a single structure that facilitates fluid flow without separate junctions or connections. During operation, cooling fluid enters cooling fluid delivery sub-stack 28 via cooling fluid inlet port 30 and flows axially through stator 10 along axial passage 32, and then radially inwards through cooling fluid outlet port 33.

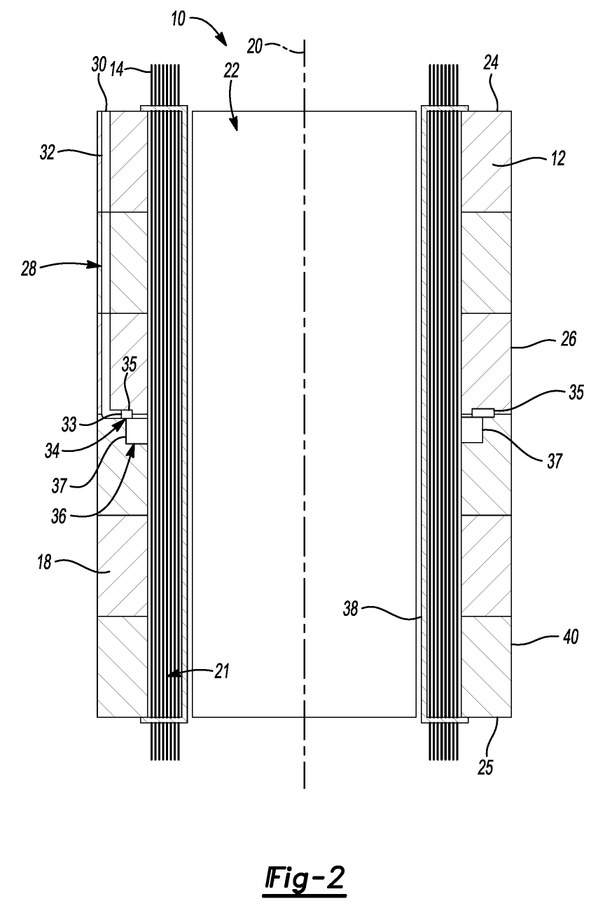

FIG. 2 shows a cross-sectional view of stator 10 taken along line A-A of FIG. 1. Stator 10 includes cooling fluid delivery sub-stack 28 extending from axial face 24. Stator 10 also includes cooling fluid delivery sub-stacks 34, 36. As will be described in more detail below, cooling fluid delivery sub-stack 34 transfers cooling fluid circumferentially along a circumference of stator 10, while cooling fluid delivery sub-stack 36 facilitates the transfer of cooling fluid radially into axial slots 21 to cool a surface of axial slots 21 and windings 14 disposed therein.

Stator 10 includes an inner circumference 38 and an outer circumference 40 that are each concentric with central axis 20. Inner circumference 38 extends between axial faces 24, 25 and defines cylindrical void 22. Outer circumference 40 extends between axial faces 24, 25 and defines cylindrical face 26.

Cooling fluid outlet port 33 is positioned between cooling fluid delivery sub-stacks 28, 34 and is configured to transfer cooling fluid from cooling fluid delivery sub-stack 28 into cooling fluid delivery sub-stack 34, thereby creating a continuous fluid flow path between the two sub-stacks. Although FIG. 2 shows axial passage 32 and cooling fluid outlet port 33 as distinct components, axial passage 32 and cooling fluid outlet port 33 are continuous with each other, forming a single structure that facilitates fluid flow without separate junctions or connections.

Cooling fluid delivery sub-stack 34 includes annular passage 35, which extends circumferentially around an intermediate circumference of stator 10, encircling axial slots 21. The intermediate circumference lies between inner circumference 38 and outer circumference 40. Annular refers to passage 35 forming a continuous, circular loop, while circumferentially describes that passage 35 follows a circumference of lamination 18. Annular passage 35 may be coaxial with central axis 20.

Annular passage 35 is an annular loop embedded into a surface of a lamination 18, extending partway through the thickness and annularly therearound. A surface of an adjacent lamination 18 seals annular passage 35. For example, if stator 10 has 500 sequentially numbered laminations, annular passage 35 may be embedded into a bottom surface lamination 18 numbered 250, with the top surface of lamination 18 numbered 251 sealing annular passage 35. Alternatively, annular passage 35 may be in a top surface of lamination numbered 250, with the bottom surface of lamination numbered 249 sealing annular passage 35. Annular passage 35, however, may be formed at different positions within the stack. Lamination 18 with annular passage 35 embedded within it may have an increased thickness compared to other laminations 18 in the stack. The required thickness may depend on the coolant flow needs of stator 10. For example, if annular passage 35 extends deeper into lamination 18, it can increase coolant volume and/or flow rate. During operation, cooling fluid enters cooling fluid delivery sub-stack 34 through cooling fluid outlet port 33 and flows annularly and circumferentially around stator 10 via annular passage 35. Cooling fluid outlet port 33 and annular passage 35 are coplanar with each other and may defined by the same lamination 18.

Cooling fluid delivery sub-stack 36 includes a plurality of slot inlet ports 37. Each slot inlet port 37 terminates into or is in registration with one of axial slots 21. Portions of slot inlet ports 37 vertically overlap with portions of annular passage 35. Slot inlet ports 37 are configured to receive cooling fluid from annular passage 35 and facilitate the transfer of the cooling fluid into each of axial slots 21, allowing the cooling fluid to flow between sub-stacks 34, 36. Each slot inlet port 37 is therefore positioned between annular passage 35 and an axial slot 21. Slot inlet ports 37 may be formed by a plurality of radially extending cutouts in some laminations 18 in the stack. Adjacent laminations 18 having these radially extending cutouts cooperate to form slot ports 37. Laminations 18 with a slot inlet port cutout may be positioned above or below lamination 18 defining annular passage 35, depending on which face of lamination 18 annular passage 35 is embedded into. For example, if stator 10 has 500 sequentially numbered laminations and an annular passage is defined in the bottom surface of lamination 18 numbered 250, a plurality of radially extending cutouts in laminations 18 numbered 251-275 may cooperate to define slot inlet ports 37. Other amounts and ranges of adjacent laminations 18 may cooperate to form slot inlet ports 37, and slot inlet ports 37 may be formed at different positions within the stack.

Since portions of slot inlet ports 37 overlap with portions of annular passage 35, a flow path for a cooling fluid exists between annular passage 35, slot inlet ports 37, and axial slots 21. The number of laminations 18 required to define slot inlet ports 37 may depend on the coolant flow requirements through stator 10. For example, a greater number of laminations 18 cooperating to form slot inlet ports 37 can increase coolant volume and/or coolant flow rate into slots 21, allowing for a higher coolant capacity. Furthermore, a larger number of laminations 18 may reduce head losses in the system’s fluid flow path.

During operation, cooling fluid flows in a radial direction through slot inlet ports 37 and into axial slots 21. In axial slots 21, the cooling fluid then flows bi-directionally and axially through axial slots 21, cooling windings 14 disposed therein and cooling a surface therein. Bi-directionally means a portion of the cooling fluid moves towards axial face 24, while another portion moves towards axial face 25. Cooling a surface within slots 21 cools stator 10 itself. In some embodiments, the cooling fluid comes into direct contact with windings 14. In other embodiments, where windings 14 are encased in an insulating material or varnish, the cooling fluid contacts the outer surface of the insulating material or varnish.

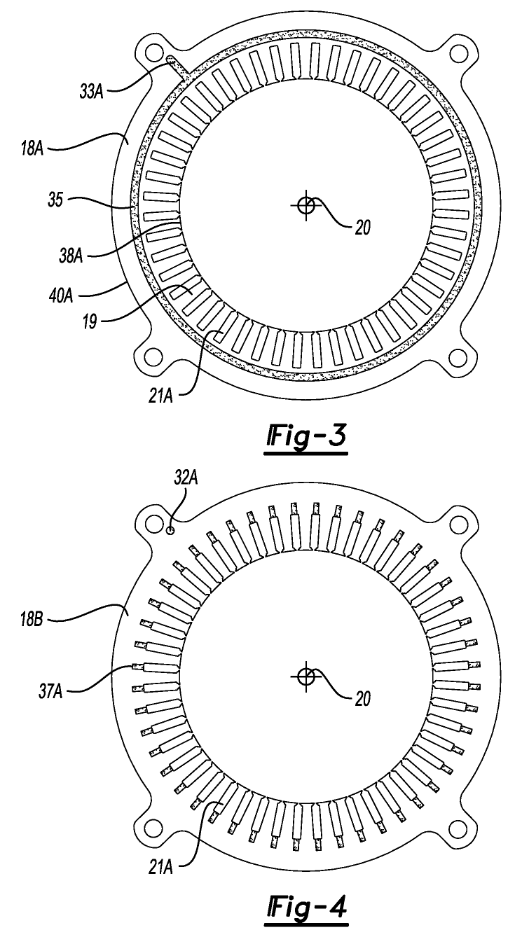

FIG. 3 provides a cross-sectional view of stator 10 taken along line B-B of FIG. 1 and illustrates an embodiment of a lamination 18A having an annular passage. As depicted, lamination 18A features a plurality of teeth 19 extending radially inward toward inner circumference 38A of lamination 18. The space between adjacent teeth 19 defines a slot 21A. When multiple laminations 18A are stacked and oriented so that teeth 19 of adjacent laminations 18 are aligned, individual slots 21A combine to form continuous axial slots 21 that extend axially through stator 10. When multiple laminations 18 are stacked, inner circumferences 38A and outer circumferences 40A of individual laminations 18 align to form inner circumference 38 and outer circumference 40.

Lamination 18A includes annular passage 35. Annular passage 35 is a circular channel partially embedded into the surface of lamination 18A. In this context, embedded means that the passage extends partway through the lamination’s thickness rather than being fully enclosed within it or passing completely through. The depth of annular passage 35 may vary based on cooling requirements. For instance, a shallower depth may suffice for lower coolant flow needs, while a deeper passage can increase coolant volume and flow rate for cooling efficiency. Lamination 18A may also include cutout 33A. When multiple laminations having cutout 33A are stacked, cutout 33A in adjacent laminations cooperate to form cooling fluid outlet port 33.

FIG. 4 provides another cross-sectional view of stator 10 taken along line C-C of FIG. 1. Lamination 18B includes circular cutout 32A. When multiple laminations 18 are stacked, cutout 32A in adjacent laminations cooperate to form axial passage 32 of cooling fluid delivery sub-stack 28. Lamination 18B may also include a plurality of radially extending cutouts 37A. Each radially extending cutout 37A extends radially inward towards inner diameter of lamination 18B and terminates into slot 21A. Each slot 21A has an associated radial cutout. When multiple laminations 18 are stacked, radially extending cutouts 37A in adjacent laminations 18 cooperate to form slot inlet ports 37.

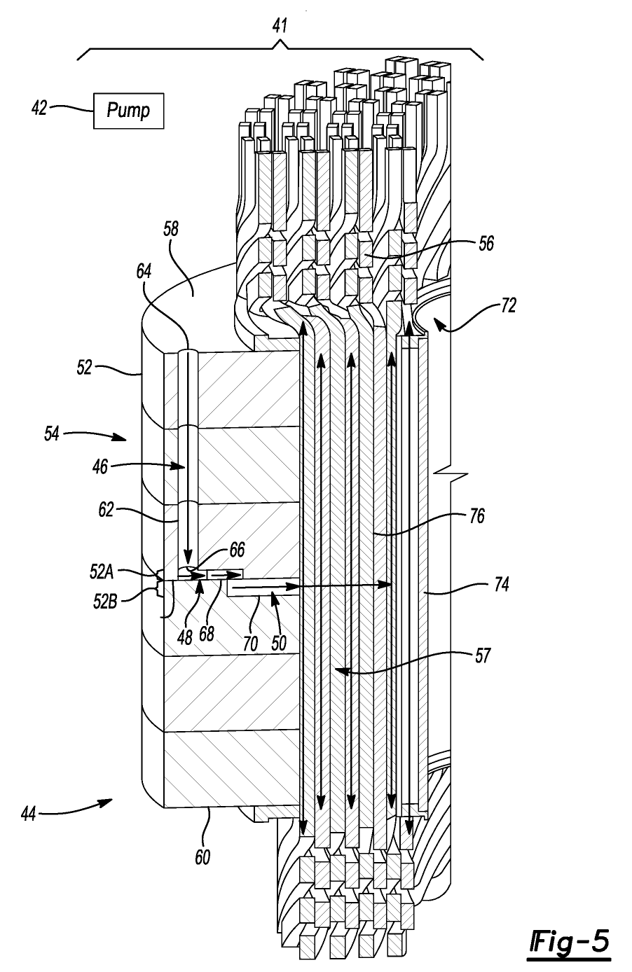

FIG. 5 illustrates a system 41 for cooling stator 44. System 41 includes pump 42 and stator 44. Pump 42 may correspond to components of a vehicle, such as an oil pump or coolant pump. Pump 42 may be mechanically driven or electrically powered. Pump 42 is configured to provide a flow of cooling fluid through the cooling fluid delivery sub-stacks of stator 44. The cooling fluid may be oil-based or glycol-based, though other options are possible. Stator 44 includes cooling fluid delivery sub-stacks 46, 48, 50. Cooling fluid delivery sub-stack 46 may correspond to cooling fluid delivery sub-stack 28. Cooling fluid delivery sub-stack 48 may correspond to cooling fluid delivery sub-stack 34, and cooling fluid delivery sub-stack 50 may correspond to cooling fluid delivery sub-stack 36.

Stator 44 includes a plurality of stacked laminations 52 forming core 54. Stator 44 also includes a plurality of windings 56 supported by core 54. Each lamination 52 features a plurality of slots, and when laminations 52 are stacked, the slots cooperate to form a plurality of axial slots 57 that extend between axial faces 58, 60 of stator 44. Portions of windings 56 may be disposed within axial slots 57. While windings 56 are shown in a hairpin style assembly, other configurations are possible. Windings 56 may be surrounded by an insulating sleeve or a varnish.

Cooling fluid delivery sub-stack 46 is configured to transfer coolant from axial face 58 towards a central lamination 52 in the stack. Therefore, only some laminations 52 in the stack define cooling fluid delivery sub-stack 46. Cooling fluid delivery sub-stack 46 may terminate at locations other than the center of the stack. Cooling fluid delivery sub-stack 46 includes axial passage 62, which passes through and is defined by some laminations 52 in the stack. Cooling fluid delivery sub-stack 46 also has a cooling fluid inlet port 64 disposed on axial face 58, which may be a circular hole in the top surface of a first lamination 52 in the stack. Cooling fluid delivery sub-stack 46 also includes cooling fluid outlet port 66, which may be located in the middle of the stack. Cooling fluid outlet port 66 traverses radially inward from the termination of axial passage 62 towards an inner diameter of stator 44. Cooling fluid inlet port 64, axial passage 62, and cooling fluid outlet port 66 are configured to be in fluid communication with each other. Each lamination that contributes to axial passage 62 includes a circular cutout. When these laminations 52 are stacked together, the cutouts align and cooperate across multiple laminations 52 to collectively form and define axial passage 62. Similarly, cooling fluid outlet port 66 may be defined by a cutout in each lamination 52 by which cooling fluid outlet port 66 traverses. Each cutout in these laminations 52 cooperates to form and define cooling fluid outlet port 66. As explained earlier, cooling fluid outlet port 66, in some embodiments, may only be in one lamination 52 depending on cooling needs.

Cooling fluid delivery sub-stack 48 is configured to transfer a cooling fluid circumferentially around core 54 and includes annular cooling fluid passage 68. Annular passage 68 extends circumferentially around core 54. Cooling fluid outlet port 66 connects between cooling fluid sub-stack 46 and cooling fluid delivery sub-stack 48. Because cooling fluid outlet port 66 traverses radially inwards from the termination of axial passage 62 towards the inner circumference of stator 44, annular passage 68 is between axial passage 62 and inner circumference of stator 44. Put differently, annular passage 68 is positioned radially between axial passage 62 and inner circumference of stator 44. Cooling fluid outlet port 66 and annular passage 68 are coplanar and may be defined by the same lamination 52. For example, lamination 52A has annular passage 68 and cooling fluid outlet port 66 embedded into its bottom surface.

Cooling fluid delivery sub-stack 50 is configured to transfer a cooling fluid radially into the axial slots of stator 44 from annular passage 68. Cooling fluid delivery sub-stack 50 includes a plurality of slot ports 70. Each slot port 70 connects between annular passage 68 and an axial slot 57. Each lamination 52 that contributes to slot ports 70 includes a radially extending cutout. When these laminations 52 are stacked together, the radially extending cutouts align and cooperate to form and define slot ports 70. Laminations 52 with a slot inlet port cutout may be positioned above or below the lamination 52 having annular passage 68, depending on which face of a lamination 52 that annular passage 68 is embedded into. Lamination group 52B can be defined as the set of laminations 52 that work together to form the plurality of slot ports 70.

Lamination group 52B and lamination 52A may be adjacent to allow cooling fluid to flow from annular passage 68 into slot ports 70. More specifically, a portion of each slot port 70 overlaps with annular passage 68, forming a connecting interface between each slot port 70 and annular passage 68. Once the cooling fluid enters axial slots 57 from slot inlet ports 70, a portion of the fluid moves towards axial face 58, while another portion moves towards axial face 60. Therefore, the cooling fluid in axial slots 57 can be characterized as flowing bi-directionally through stator 44.

Stator 44 also includes a cylindrical void 72 defined by an inner diameter of each lamination 52 in the stack. Cylindrical void 72 extends between axial faces 58, 60. A sealing layer 74 may be disposed on the inner diameter of stator 44 to seal the axially extending slots 57 from cylindrical void 72, keeping cooling fluid within axial slots 57. Sealing layer 74 may be a sleeve extending through cylindrical void and maybe metal, plastic, or other suitable material. The sealing layer may be press fit into cylindrical void 72.

In operation, pump 42 circulates the cooling fluid through cooling loop 76, which flows through cooling fluid delivery sub-stacks 46, 48, and 50. Cooling loop 76 is illustrated as beginning at cooling fluid delivery sub-stack 46, where the cooling fluid flows from axial face 58 through axial passage 62 into annular passage 68. Cooling loop 76 is a continuous loop and, therefore, has no beginning or end. The cooling fluid exits cooling fluid delivery sub-stack 46 through cooling fluid outlet port 66, which connects to annular passage 68 in cooling fluid delivery sub-stack 48. Annular passage 68 distributes the cooling fluid circumferentially around stator 44. Slot ports 70 connect annular passage 68 of cooling fluid delivery sub-stack 48 to cooling fluid delivery sub-stack 50. In cooling fluid delivery sub-stack 50, the cooling fluid moves radially between annular passage 68 and axial slots 57. Within axial slots 57, the cooling fluid travels bi-directionally along the axial directions and may contact the surfaces of axial slots 57 and/or windings 56 housed within them. Sealing layer 74 confines the cooling fluid to within axial slots 57. By contacting the windings and/or surfaces within axial slots 57, the cooling fluid helps cool windings 56 and stator 44. In some embodiments, the cooling fluid may also contact an insulating sleeve surrounding the windings or a varnish coating the windings. Additionally, as the cooling fluid moves through cooling fluid delivery sub-stacks 46, 48, it further aids in cooling stator 44. Once the cooling fluid reaches axial faces 58, 60 in cooling fluid delivery sub-stack 50, it may return to pump 42 through a sump or another suitable return mechanism.

What is claimed is:

1. A stator for an electric machine comprising:
a plurality of laminations stacked to form a stator core defining a plurality of axially extending slots, one of the laminations partially defining an annular ring encircling the slots, and another of the laminations in direct contact with the one defining a plurality of ports extending from the slots and overlapping with portions of the annular ring such that the stator core defines fluid pathways from the annular ring, through the ports and slots, and to both axial ends of the stator core.

2. The stator of claim 1, wherein the stator core further defines a cylindrical void extending between the axial ends, further comprising a sealing layer disposed within the cylindrical void and configured to seal the slots from the cylindrical void.

3. The stator of claim 1, wherein a first of the laminations defines an inlet.

4. The stator of claim 3, wherein some of the laminations define an axial passage extending between the inlet and the one of the laminations.

5. The stator of claim 1, wherein the one of the laminations is disposed halfway between the axials ends.

6. The stator of claim 1 further comprising windings disposed within the slots.

7. A vehicle propulsion system comprising:
an electric machine including a stator having a core defining slots for windings and a cooling path configured to direct fluid from an inlet on one end of the core to the slots via an axial channel and a circumferential ring around the slots; and
a pump configured move the fluid through the cooling path.

8. The vehicle propulsion system of claim 7, wherein the axial channel is radially outside the circumferential ring.

9. The vehicle propulsion system of claim 8 further comprising a plurality of laminations stacked to form the core, wherein the axial channel is defined by some of the laminations.

10. The vehicle propulsion system of claim 9, wherein the circumferential ring is defined by other of the laminations.

11. An electric machine comprising:
a stator core defining a plurality of slots configured to accommodate windings therein, a circumferential channel radially outside of and in fluid communication with the slots, and an axial channel extending between and in fluid communication with the circumferential channel and an end of the stator core.

12. The electric machine of claim 11 further comprising a plurality of laminations stacked to define the stator core, wherein an adjacent pair of the laminations defines the circumferential channel.

13. The electric machine of claim 12, wherein one of the adjacent pair further defines ports in fluid communication with the circumferential channel and slots.

14. The electric machine of claim 13, wherein the one of the adjacent pair further defines the ports such that each of the ports is in registration with one of the slots.

15. The electric machine of claim 11, wherein a length of the axial channel is less than a length of the stator core.

16. The electric machine of claim 11, wherein the axial channel is radially outside of the circumferential channel.

17. The electric machine of claim 11, wherein the circumferential channel completely encircles the slots.
